(19) United States
(12) Patent Application Publication
(10) Pub. No.: US 2026/0327861 A1
(43) Pub. Date: Oct. 22, 2026

(54) Dyeing Method for Coloration of Ultra-High Molecular Weight Polyethylene Fiber

(71) Applicant: Drexel University, Philadelphia, PA (US)

(72) Inventors: Zachary Ryan Hinton, Newark, DE (US); Christopher Keton Henry, Chester, VA (US); Nicolas Javier Alvarez, Drexel Hill, PA (US); Thamires Andrade Lima, Philadelphia, PA (US); Madhu Anand, Allentown, PA (US)

(21) Appl. No.: 19/109,499

(22) PCT Filed: Sep. 12, 2023
(86) PCT No.: PCT/US2023/032525

§ 371 Date: Mar. 6, 2025

Related U.S. Application Data
(60) Provisional application No. 63/405,534, filed on Sep. 12, 2022.
(60) Provisional application No. 63/437,834, filed on Jan. 9, 2023.

(51) Int. Cl. D01F 11/06; D01D 5/26; D01D 10/06; D01F 6/46; D01H 7/02

(52) U.S. Cl. CPC D01F 11/06; D01D 5/26; D01D 10/06; D01F 6/46; D01H 7/02; D10B 2321/0211; D10B 2401/063

(57) ABSTRACT

A method or coloring a ultra-high molecular weight polyethylene (UHMWPE) fiber includes the steps of: gel spinning the UHMWPE fiber, the fiber having an amorphous content of about 30% to about 60%; winding the fiber on a perforated spool for dyeing; placing the spool-wound fiber into a super critical CO2 (scCO2) dyeing vessel; infusing a dye in the scCO2 into the spool-wound fiber; removing the spool-wound fiber from the dyeing vessel; unwinding the fiber from the spool; and hot drawing the fiber by a predetermined draw ratio to obtain a desired tensile strength and modulus for the fiber.

### BACKGROUND OF THE INVENTION

### Field of the Invention

The invention relates to a reliable method of dyeing ultramolecular high weight polyethylene (UHMWPE).

### Description of the Related Art

UHMWPE is a widely used performance plastic because of its superior strength and low weight to modulus ratio. With a higher specific modulus and strength than steel, spider silk, and aramid fibers (Kevlar), UHMWPE fibers are finding uses in various industrial fields requiring high tensile properties, e.g., in body armor, polymer composites, ropes, fishing lines/commercial fishing nets, parachutes and balloon cords, tethers used in space and medical devices. There is a growing market for use of UHMWPE fibers in textile materials such as in shoes, sportswear, and other consumer goods.

One issue limiting the use of UHMWPE fibers in commercial textile products is the lack of availability of different colors. The adoption of UHMWPE fibers in commercial products requires control of the coloration of the material. More specifically, the textile industry requires the ability to produce or match UHMWPE fibers to any target color based on the requirements of the customer. It is generally considered that UHMWPE fibers cannot be dyed using conventional dyeing systems due to extreme hydrophobicity and high crystallinity (>85%).

Three solutions have been proposed in the literature to color UHMWPE with varying degrees of success, including: Method (1)—infusing organic dyes into the stretched polyethylene; Method (2)—incorporating pigment or dye particles in the polymer, such as carbon black in the fiber spinning process; and Method (3)—coloration of UHMWPE using a colored coating on the surface of the UHMWPE fibers; because of poor adhesive properties of UHMWPE, the fibers need to undergo surface treatment to improve adhesion of the coating to the fiber.

Method (2) is practiced but has the disadvantage because of (a) the potential loss of properties with particulate pigment or dye additives included in the polymer and (b) the need for cleaning of the extrusion equipment and nozzles between color color changes to prepare fibers of different colors. Since UHMWPE is an expensive polymer, this adds a significant cost to preparing colored fibers. Prior art has proposed using smaller pigment particle sizes to minimize the loss of mechanical properties of high strength UHMPE stretched fibers. Method (3) has limited life because the surface coloration is damaged with use.

The success of Method (1) is argued to strongly depend on the shape and structure of the dye molecule being infused and the limited dye capacity within the highly oriented and crystalline structure of UHMWPE fibers. Method (1) is also limited by the color palette possible and the amount of dye that can be incorporated into the fiber, which limits the depth of color and color intensity that can be achieved. For example, researchers have reported success of dyeing UHMWPE with “super” hydrophobic dyes having long alkyl substituents, such as alkyl modified anthraquinoid dyes. Prior work has shown that using supercritical carbon dioxide (scCO₂) in the presence of a co-solvent decalin improves the dye uptake in UHMWPE fabrics. However, this dyeing process caused a reduction in mechanical properties of UHMWPE fabrics.

A solution is needed to allow dyeing of UHMWPE high strength fibers and yarns after fabrication of the fibers and allows greater number of the dyes that may be used with UHMWPE to achieve a wide color palette.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a method for coloring a ultra-high molecular weight polyethylene (UHMWPE) fiber that includes the steps of: gel spinning the UHMWPE fiber, the fiber having an amorphous content of about 30% to about 60%; winding the fiber on a perforated spool for dyeing; placing the spool-wound fiber into a dyeing vessel containing supercritical CO₂ (scCO₂) as a solvent for the organic dye or dyes; dissolving a dye or dyes in the scCO₂ and infusing dye into the fiber wound on a perforated spool; removing the spool-wound fiber from the dyeing vessel; unwinding the fiber from the spool; and hot drawing the fiber by a predetermined draw ratio to obtain a desired tensile strength and modulus for the fiber.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a schematic drawing of an exemplary method of producing dark colored ultra-high molecular weight polyethylene yarns according to an exemplary embodiment of the present invention;

FIG. 2A1 is a photograph of a drawn UHMWPE Spectra™ fiber having a 0.25 mm diameter;

FIG. 2A2 is a photograph of the drawn UHMWPE Spectra™ fiber of FIG. 2A1, the fiber having been drawn to a 0.2 mm diameter;

FIG. 2B1 is a photograph of a PET fiber having a 0.29 mm diameter;

FIG. 2B2 is a photograph of the PET fiber of FIG. 2B1, the fiber having been drawn to a 0.01 mm diameter;

FIG. 2C1 is a photograph of an inventive fiber dyed with red dye, the fiber having a 0.61 mm diameter;

FIG. 2C2 is a photograph of the inventive fiber of FIG. 2C1, the fiber having been drawn to a 0.20 mm diameter;

FIG. 2C3 is a photograph of the inventive fiber of FIG. 2C1, the fiber having been drawn to a 0.14 mm diameter;

FIG. 3A is a graph of L value vs. diameter of the as-spun fiber with red dye vs. the PET fiber;

FIG. 3B is a graph of a value vs. diameter of the as-spun fiber with red dye vs. the PET fiber;

FIG. 3C is a graph of b value vs. diameter of the as-spun fiber with red dye vs. the PET fiber;

FIG. 4A1 is a photograph of a drawn UHMWPE Spectra™ fiber having a 0.25 mm diameter;

FIG. 4A2 is a photograph of the drawn UHMWPE Spectra™ fiber of FIG. 4A1, the fiber having been drawn to a 0.02 mm diameter;

FIG. 4B1 is a photograph of a PET fiber having a 0.45 mm diameter;

FIG. 4B2 is a photograph of the PET fiber of FIG. 4B1, the fiber having been drawn to a 0.01 mm diameter;

FIG. 4C1 is a photograph of an inventive fiber dyed with green dye, the fiber having a 0.52 mm diameter;

FIG. 4C2 is a photograph of the inventive fiber of FIG. 4C1, the fiber having been drawn to a 0.34 mm diameter;

FIG. 4C3 is a photograph of the inventive fiber of FIG. 4C1, the fiber having been drawn to a 0.17 mm diameter;

FIG. 4C4 is a photograph of the inventive fiber of FIG. 4C1, the fiber having been drawn to a 0.06 mm diameter;

FIG. 5A is a graph of L value vs. diameter of the as-spun fiber with green dye vs. the PET fiber;

FIG. 5B is a graph of a value vs. diameter of the as-spun fiber with green dye vs. the PET fiber;

FIG. 5C is a graph of b value vs. diameter of the as-spun fiber with green dye vs. the PET fiber;

FIG. 6A1 is a photograph of a drawn UHMWPE Spectra™ fiber having a 0.36 mm diameter;

FIG. 6A2 is a photograph of the drawn UHMWPE Spectra™ fiber of FIG. 6A1, the fiber having been drawn to a 0.02 mm diameter;

FIG. 6B1 is a photograph of a PET fiber having a 0.44 mm diameter;

FIG. 6B2 is a photograph of the PET fiber of FIG. 6B1, the fiber having been drawn to a 0.01 mm diameter;

FIG. 6C1 is a photograph of an inventive fiber dyed with violet dye, the fiber having a 0.40 mm diameter;

FIG. 6C2 is a photograph of the inventive fiber of FIG. 6C1, the fiber having been drawn to a 0.22 mm diameter;

FIG. 6C3 is a photograph of the inventive fiber of FIG. 6C1, the fiber having been drawn to a 0.17 mm diameter;

FIG. 6C4 is a photograph of the inventive fiber of FIG. 6C1, the fiber having been drawn to a 0.08 mm diameter;

FIG. 7A is a graph of L value vs. diameter of the as-spun fiber with violet dye vs. the PET fiber;

FIG. 7B is a graph of a value vs. diameter of the as-spun fiber with violet dye vs. the PET fiber;

FIG. 7C is a graph of b value vs. diameter of the as-spun fiber with violet dye vs. the PET fiber; and

FIG. 8 is a graph of modulus vs. draw ratio for white (undyed), black, brown, green, and red fibers.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

There is currently no known technique or technique in the literature that is able to color UHMW-polyethylene fibers to deep, dark colors, other than by addition of pigments during the fiber extrusion process, which has many manufacturing limitations which are expensive and result in loss of mechanical properties of the colored fiber. This is especially true for low denier or very fibers or yarns (e.g. below 50 denier) Many industries would be interested in dark colored UHMWPE fibers. Typical methods of coloring polymer fibers include the use of organic solvents or excessive amounts of water which are both environmentally unfavorable as well as costly. The use of supercritical fluid reduces the material cost and toxicity of the coloration medium while maintaining (if not increasing) the efficacy of color uptake on the material. Furthermore, attempts to color highly oriented polymer fibers (e.g. UHMWPE) lead to low color uptake, particularly for dark and vivid colors and as reported in the literature only a limited number of organic disperse dyes are useable because of the shape of the dye molecule and the constraints of the internal morphology of the highly drawn UHMWPE fibers. Our data on the disclosed invention demonstrates the ability to achieve higher color uptake than any other process reported in the literature. Furthermore, the coloration process does not impede mechanical properties. We have shown that dyeing of the as-spun pre-stretched UHMWPE fiber is capable of producing dark brown and black colors which were targeted, while dyeing of previously oriented UHMWPE absorbs dyes selectively leading to unpredictable colors that are not near targets. Additionally, prior art suggests only dyes with planar chemical structures are successfully incorporated into oriented UHMWPE, while the current invention illustrates that a broader category of dyes (including FDA approved for medical/pharmaceutical applications) can be incorporated into as-spun pre-stretched fibers and are retained in the polymer during the stretching and orienting process. The invention also comprises a process which decreases the overall dyeing time needed to achieve desired dye uptake/coloration, reducing the production costs.

The inventors have surprisingly found that (a) we can achieve colors with dyes that would normally not be infused into a fully drawn UHMWPE fiber and (b) increase dye uptake in the polymer, (c) achieve target tensile properties without losing tensile properties in the presence of the dyes or colorants (d) decrease the dyeing time versus dyeing a highly drawn UHMWPE fiber or yarn and (e) the color uptake is permanent and does not leach out. The inventors have also demonstrated that the dyes are wholly incorporated in the within the polymer and does not leach out of the polymer by even exposure to common water based and organic solvents. This is a very significant advantage vs for example with UHMWPE colored using coatings.

Disclosed is a method for dyeing UHMWPE in supercritical carbon dioxide (“scCO₂”) allowing (a) uptake of large amount of dyes into the UHMWPE, (b) no loss in mechanical properties, (c) predictable color of the dyed fiber (d) much shorter dyeing time, (e) no penalty associated with changing colors in the UHMWPE production process, (f) lower cost of dyeing and (g) permanent incorporation of the dye into the polymer without loss over time and use. In addition, compared with incorporation of pigments such as carbon black that are often in the several micron size range, the dye molecules dissolved in scCO₂ are incorporated into the polymer at the molecular level. When dye molecules are incorporated at the molecular level this reduces the possibility of reduction in mechanical properties of the fibers due to pigment particles which act like occlusions or defects in the fiber structure. In the new method, the UHMWPE fiber is removed from the production process prior to the drawing operation, is dyed off-line in scCO₂ and returned to the production line for the hot drawing and stretching to achieve the high tensile properties of the drawn UHMWPE fibers.

The fiber removed for dyeing prior to drawing or stretching will be referred to as as-spun or unstretched UHMWPE fiber. The as-spun fiber is not highly oriented, has an amorphous content of about 30% to 60% (i.e. crystalline content of 70% to 40%), depending on the gel processing conditions, and has high capacity for dye uptake. Because of the large amorphous content, the diffusion rate of the dye into the fiber is also increased. This is to be contrasted with an amorphous content of less than 10% and more often less than 5% for the stretched or drawn UHMWPE high strength fiber. A large amount of dye can be incorporated into the as-spun fiber at the molecular level because a large fraction of the polymer is an amorphous state. The as-spun fiber with large dye or color uptake is stretched or drawn to a smaller diameter high strength fiber. We have discovered that the high strength fiber prepared by our process has higher dye content versus fiber dyed after drawing. The inventors have also discovered that the dyeing time for as-spun fiber for high dye uptake is reduced by more than 50% vs dyeing a stretched fiber.

In the present invention the dye or a dye mixture is incorporated into as-spun fiber using scCO₂ as the dye solvent. In an exemplary embodiment, the CO₂ is preferably compressed to a pressure of about 250 bar and a temperature of about 120 C in the scCO₂ dyeing vessel. The pressure may be varied from about 150 bar to 300 bar and the temperature may be varied from about 50 C to 130 C or below the melting point of the polymer. Many organic dyes soluble in scCO₂ can be incorporated into the unstretched UHMWPE fiber. Examples of organic dyes that may be used with UHMWPE are dyes used for dyeing polyester, nylon and other man-made polymers in the textile industry. These dyes are referred to as disperse dyes in the textile industry and include dye molecules with structures such as anthraquinone-, azo-, di-azo- di-azo, an anthraquinone, and a “disperse” type dye.

Some of the disperse dyes or colorants are approved by FDA for use in food and medical device applications. Individual primary color dyes or dye mixtures may be used to achieve a desired color in the fiber. The as-spun fiber is capable of accepting many more dyes vs the highly stretched fiber. Prior art teaches that dyes with preferred molecule size and shape are preferred for dyeing stretched UHMWPE fiber or polymer. We find evidence of this when dyeing with dye mixtures—i.e. some dyes migrate into the UHMWPE polymer fiber while others are retarded in dye uptake. This restriction is removed for the as-spun fiber allowing one to prepare dyed and stretched fibers with different colors and compositions vs dyeing stretched UHMWPE fibers. This is a very surprising finding and allows much greater flexibility in dye selection and use with the UHMWPE fibers, contrary to prior art.

An exemplary embodiment of the invention comprises the process of applying color (e.g. dye) to as-spun or partially oriented (between draw ratios of 0 and ~50) polyethylene polymer fibers (e.g. UHMWPE) using supercritical fluids (e.g. CO₂) as the dyeing medium. The process comprises the steps of spinning polyethylene fibers with an amorphous content between 30 and 60%, with an optional pre-orientating step, and treating said fiber with a specific concentration of supercritical CO₂ soluble dyes in a pressure vessel at set pressure and temperature. The fiber is left in the pressure vessel for a set time of less than 2 hours. The colored fiber is post drawn to a crystallinity between 60 and 99% to increase mechanical properties, i.e. modulus and strength. The amount of amorphous polyethylene and the overall crystalline structure are key parameters to increase dye penetration into the fiber, i.e. increase color or dye uptake. Furthermore, the success of this technique strongly depends on the dye chemistry and concentration of dye in the dyeing vessel i.e. the dyeing conditions in the supercritical CO₂ dyeing process. The invention can also be extended to other polymer fibers which may undergo orientation in their production, e.g. polypropylene (PP), polyvinylidene fluoride (PVDF), etc.

UHMWPE fibers offer incredible tensile properties to mass ratios and are finding increased use in commercial applications. For example, a recent market assessment of UHMWPE fibers projects a maintained growth rate of 15% over the next five years. While the properties of UHMWPE fibers set them apart from other textile materials, UHMWPE poses some technological challenges that limit its wide-spread adoption. For example, UHMWPE is considered very difficult to color due to its high hydrophobicity and crystalline content. The present invention provides a new method of using scCO₂ to dissolve and disperse dyes into the amorphous domains of as-spun UHMWPE fibers prior to drawing. Data clearly shows that this inventive method is very successful at increasing the concentration of dye into the final fiber to achieve deep, saturated colors.

The inventive process is significantly safer and environmentally friendly than traditional textile dyeing processes which use hazardous organic solvents or use large amounts of water that result in significant water pollution, and has the added benefit of component recyclability, cost effectiveness, and decreased processing times.

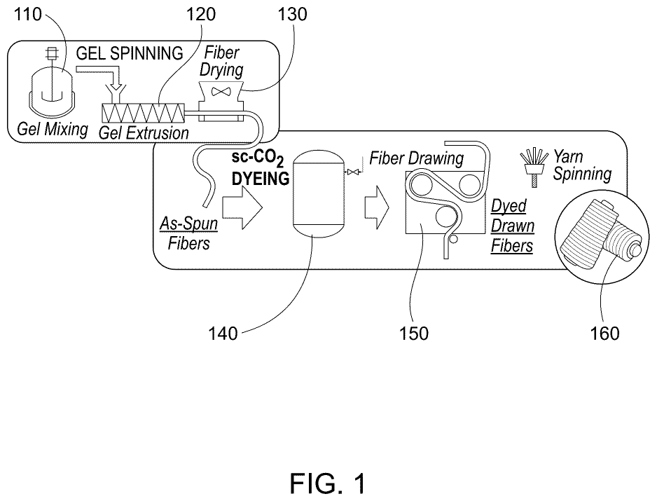

The inventive approach uses sc-CO₂ to dye the fiber after the spinning and drying process and before drawing (FIG. 1). The advantage to this approach is the significant presence of amorphous domains in the as-spun fiber, where the dye molecules and sc-CO₂ easily diffuse and the dye can accumulate. A method was developed for measuring colors on individual fibers or yarns.

The unique processing route of UHMWPE means that traditional polymer fiber dyeing techniques do not necessarily apply. While commodity plastics such as HDPE and LDPE can be manufactured into fibers in the melt state (melt spinning or extrusion), high performance UHMWPE fibers are limited to the gel spinning. UHMWPE gels typically consist of about 2-10% UHMWPE in a high boiling point solvent, which facilitates processing by lowering the crystalline domains. The gel can then be extruded into a fiber using a fiber spinning process, and is practiced commercially to produce UHMWPE fibers. The extruded fiber with little or no orientation or stretching is then dried to remove the high boiling solvent. The dried fiber is drawn or stretched to achieve high strength.

Strength is developed by a drawing process wherein the fiber is stretched stagewise or continuously via controlled rate and temperature to reduce the diameter up to 20-fold. The present method uses sc-CO₂ to dye the fiber after the spinning and drying process and before drawing. The advantage to this approach is the significant presence of amorphous domains in the as-spun fiber, where the dye molecules and sc-CO₂ easily diffuse into the fiber, allowing accumulation of the dye in the as-spun fibers. Following the dyeing process, fiber is stepwise or continuously drawn to increase orientation and the mechanical strength. Formation of more highly ordered crystalline domains during drawing would not be hindered as the dye molecules are confined to the amorphous domain. This effectively concentrates the dye in amorphous domains that are uniformly distributed throughout the fiber and produce a fiber with adequate color uniformity and saturation, allowing for a much simpler process to formulate new colors or to adjust existing colors.

Exact dimensions and colors were measured using optical microscopy after every drawing stage, using calibrated measurements and red, green, and blue (“RGB”) color intensities, respectively.

The present invention provides a method of dyeing UHMWPE after spinning, but before post-drawing. Using this process, superior coloration and thus the widespread adoption of UHMWPE fibers in textiles can be achieved by incorporating PE-philic (molecules that likes PE) dyes in the early stages of fiber formation using scCO₂ to trap the dye in the amorphous region of the PE. The fiber is subsequently drawn to achieve extreme tensile properties that are unaffected by the presence of dye. The process is significantly safer and more environmentally friendly than traditional textile dyeing that produces huge amounts of waste water, and has the added benefit of component recyclability, cost effectiveness, decreased processing times, and preservation of material integrity. Test results show that the inventive dyeing process significantly increases the dye uptake compared to prior art, allowing UHMWPE fibers to achieve the color of standard polyester dyed yarns.

Referring back to FIG. 1, to prepare the fiber for spinning, 99.5 wt % UHMWPE (3-6×10⁶ g/mol Sigma Aldrich CAS9002-88-4, Batch) and 0.5 wt % 2,6-di-tert-butyl-p-cresol and 3,5-di-tert-butyl-4-hydroxy-hydrocinnamte (antioxidants) were dissolved in decahydronaphthalene (Sigma Aldrich CAS911-17-8) and mixed in a 34 cm³ stainless steel cylinder 110 inside a rotary oven (not shown). The oven was held at 150 degrees C. and rotated at 20 rpm for at least 20 hours. The sample was loaded into the temperature controlled stainless steel hopper of a spinning apparatus. The spinning apparatus used a stainless steel piston with velocity control, i.e. flow-rate control. The range of flow-rates were 10-45 mm³/s and the temperature was 120 degrees C. The gel was extruded through a nylon nozzle 120 (Plastic Process Equipment, RTEG334118) with a 3.2 mm diameter opening and drawn via a take-up motor at specified windup rates. The final diameters of the as-spun fibers were 600-700 μm. The as-spun fibers were dried for 5-6 hours and then placed in a vacuum oven 130 to dry at room temperature for a minimum of 8 hours. The dried fibers were spooled and used without further processing in the supercritical dyeing setup described below. The fibers were deemed to be dry and no effort was made to quantify residual solvent in the fiber. Also used in this work for comparison are commercial stretched UHMWPE fibers from Honeywell sold under the trade name Spectra™ fibers. Spectra™ 900 uncolored UHMWPE fibers were used for dyeing work.

The dyeing process for the UHMWPE fibers comprised scCO₂ as the solvent and a series of dyes, referred to as disperse dyes and used extensively in the textile industry. Disperse dyes are typically used in dyeing polyester and nylon yarns and fabrics. Many disperse dyes are soluble in scCO₂. The dyeing of the fibers is done batchwise in a heated high pressure vessel 140 (FIG. 1). First, the UHMWPE or other textile fibers or yarns are wound on a perforated spool and placed in the high pressure vessel 140. The perforated spools may be produced from for example polypropylene or any polymer that can withstand the dyeing pressure or temperature conditions or from a metal such as stainless steel. The pressure vessel 140 is filled with CO₂ and brought to the target temperature and pressure. The dye may be placed within the dyeing vessel 140 or in a separate external vessel such as a semi-permeable pouch, which is placed in the vessel 140; the CO₂ is circulated within the vessel if the dye is placed within the vessel or circulated via the external dye containing vessel to ensure dye dissolution, contact of the dye solution with the yarns/fibers/fabrics, and uniform coloration. In an exemplary embodiment, the dye is enclosed in a semi-permeable pouch and the pouch is placed in the dyeing vessel.

The dyeing was done at 120 degrees C. and a pressure of 3750 psig (~250 bar) for 60 minutes, after which the vessel is depressurized and the dyed fibers removed, drawn on a fiber drawing apparatus 150, and wound on spools 160. Polyester yarn and fabric were dyed in the same scCO₂ vessel as UHMWPE fibers to establish the color characteristics achieved with a specific dye at pressure and temperature. The dyed polyester served as the reference or “standard color” in this evaluation. In some cases, polyester and UHMWPE fibers were dyed during the same run, to determine if there are differences in the color characteristics caused by the material structure and morphology. The materials were dyed with the following dyes in this work in Table 1 below:

TABLE 1

| | Color | Sample |
|---|---|---|
| Dye Name | Index | Result Color |
| Solvent Red 27 | C.I.26125 | Red |
| Solvent Green 3 | C.I.61565 | Green |
| Solvent Violet 13 | C.I.60725 | Blue |
| Disperse Brown 22 | C.I.11133 | Brown |
| Disperse dye Black | N/A | Black |
| mixture from Foron | | |
| (commercial dye mixture | | |
| formulated to achieve | | |
| black color | | |
| Disperse Dye Black | N/A | Black |
| mixture from Colourtex | | |
| Disperse dye Black | N/A | Black |
| mixture from Waysmos | | |

As-spun UHMWPE, highly-drawn UHMWPE yarns (from Honeywell, Spectra fibers) and polyester yarns were dyed with black and brown dyes noted in the table above. The visual results from the dyeing are shown in Table 2 below.

TABLE 2

| | | | | | | | Color |
|---|---|---|---|---|---|---|---|
| | | | | Dyeing | Color as- | | UHMWPE- |
| | Dye | | | time, | spun | Color | HonWell |
| Dye | amount | T, C | P, bar | hr | UHMWPE | Polyester | 120 D |
| Colourtex black mix | 5.00% | 120 | 250 | 1 | black | black | light pink |
| Foron black mix | 5.00% | 120 | 250 | 1 | black | dark grey | light grey |
| waysmos black mix | 5.00% | 120 | 250 | 1 | black | brown | beige |
| Disperse brown 22 | 5.00% | 120 | 250 | 1 | brown | light brown | very light |
| | | | | | | | beige |

The dyeing results clearly show that black disperse dyes when used for dyeing drawn UHMWPE result in unpredictable colors while the as-spun UHMWPE results in expected colors as in polyester. This confirms the observation in the prior art that drawn UHMWPE picks up dyes selectively depending on the structure of the organic dye resulting in unexpected colors when dyed with dye mixtures used to formulate black color. These black dye mixtures are formulated using red, blue and yellow dyes. Since only some dyes penetrate drawn UHMWPE the colors are unpredictable. The as-spun UHMWPE picks up all the dyes equally and non-selectively resulting in the expected colors. The dyes are designed for use with polyester and show the same colors in polyester and as-spun UHWPE and unexpected colors in drawn UHMWPE. In addition, the dye uptake in the Spectra fibers is very low compared to very high dye uptake in as-drawn UHMWPE as evidenced with both black and brown dyes noted in Table 2 above.

A method to quantify the dye concentration in fibers was developed. Color measurement and calibration code developed allowed us to consistently measure the real color of the fibers for each dye and fiber characteristics, i.e. fiber diameter. Typical polyester fiber or filament diameters used in textiles can range from 10 to 30 microns in diameter.

The color characteristics of the dyed fabric samples were measured using a Datacolor 600 color measurement system, which is widely used in the textile industry. The measurements were done using D65/10 lighting condition within the colorimeter. The equipment measures the L*, a*, b*, C* and H* color profiles for yarns and fabrics. The color measurement system can also be calibrated with specific dyes and dye uptakes in the yarns/fabrics to provide quantitative color measurements and for color matching.

Although a color correction routine was developed using the MSCCMN standard, it is important to validate the correction routine using additional materials. For this purpose, the corrected color of PET dyed fabric swatches was compared with the Datacolor colorimeter 600. The software setting is set to the same condition when taking all the microscopic images, including the photos for the color checker, the fabrics, and also the fibers.

The microscopic images of the fabric swatch were then color corrected using the same color correcting algorithm. The average colors' L *, a *, and b * values of the color corrected images were then compared with the L *, a *, and b * value reading from the Datacolor colorimeter 600. The letters L*, a* and b* represent each of the three values the CIELAB (International Commission on Illumination's French name, Commission Internationale de l'Eclairage) color space uses to measure objective color and calculate color differences. L* represents lightness from black to white on a scale of zero to 100, while a* and b* represent chromaticity with no specific numeric limits. a* measures green to red and b* measures blue to yellow.

By way of example only:
When L=100 and a=100, a light red is the result;
When L=100 and a=−100, a light green is the result;
L is between 30-60 for a colored fiber;
L<30 for a dark fiber; and
When L=0, light does not penetrate the fiber.

The drawing and mechanical testing of UHMWPE fibers were conducted using a VADER 1000 (Versatile Accurate Deformation Extensional Rheometer) adapted for solid mechanical testing. Both methods involved stretching fiber samples at constant velocity between two custom clamps. The drawing of the samples was performed by stretching the dyed UHMWPE fibers at 120 degrees C., which is 15 degrees C. below melting. Each drawing stage was performed stretching the fiber at constant velocity (0.5 mm/s) from 5 mm initial length to 100 mm, which is a lateral draw ratio, DR_{L}=L_{f}/L₀=20, where L_{f} is the final length and L₀ is the initial gauge length. Since slippage and non-uniform deformation can occur during drawing, the radial draw ratio, defined as DR_{D}=D₀/D_{f}, is a more accurate representation of the fiber deformation during drawing. The initial, D₀, and the final, D_{f} diameters were measured before and after drawing, respectively, using the microscope setup discussed above. Between each drawing stage, the fibers were left to cool down for 10 min before being handled. Additional drawing stages were performed by cutting a uniform section of drawn fiber, re-clamping to an initial 5 mm gap, and stretching again.

The mechanical testing of the fibers was performed at room temperature, 10 minutes after drawing, via unloading experiments. The cooled fiber samples after drawing were unloaded via a downward velocity of the top capstan. The decreasing force and displacement was measured, and the modulus was calculated using a calibrated stress-strain method. Strain calibration was performed using the “Elastic Deformation of Known Material” method to accurately correct the machine compliance. The strain calibration method was validated using three fibers with known Modulus (Nichrome, Copper and Stainless Steel).

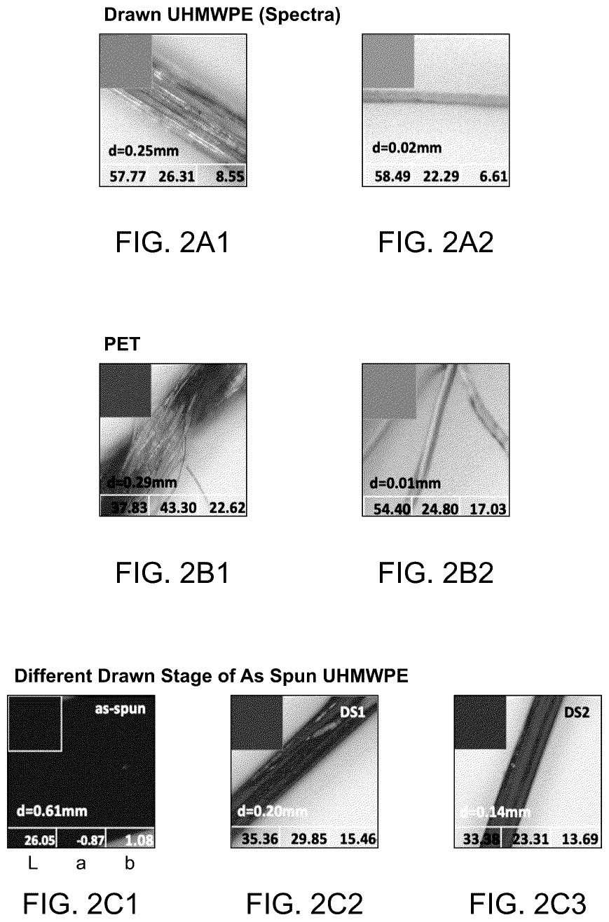

FIGS. 2A1-2C3, 4A1-4C4, and 6A1-6C4 show the color correction results of the dyed commercial UHMWPE Spectra™ fiber, PET fibers, and as-spun fibers with different draw ratios. All fibers in the same color group were dyed in the same batch. The average LAB color values of dyed fibers are shown in each image, along with the respective fiber diameters.

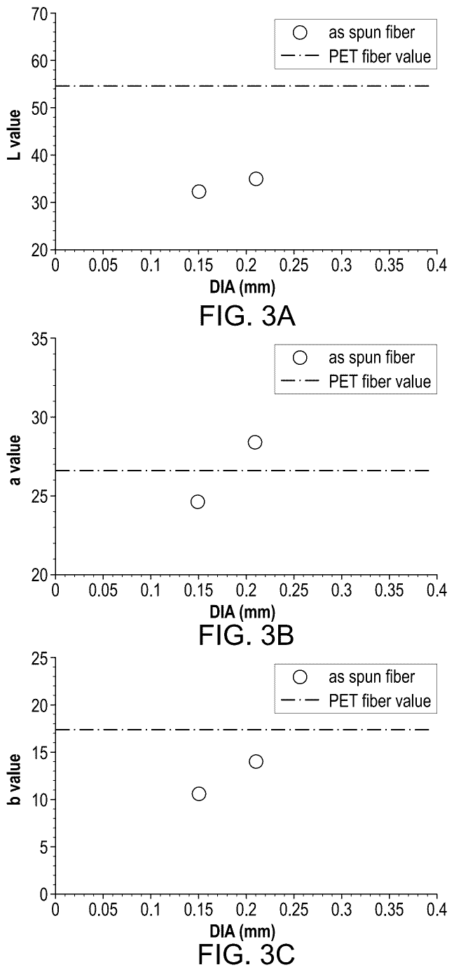

FIGS. 2A1-2C3 show that the color uptake of the three fibers is very vivid. Note that of all the dyes, the red dye had the highest uptake in the drawn UHMWPE Spectra™ fibers. The PET yarn and fibers show smaller L values and larger a and b values than the commercial UHMWPE yarn. This means that the color of the PET fibers is more concentrated and vivid than the commercial UHMWPE fibers. Interestingly, the color of the undrawn as-spun fiber was unable to be measured as the color was too saturated for the microscope setup. This means that the as-spun fiber achieved considerable dye uptake. As the as-spun fiber was drawn, the color of the fiber remained very dark compared to the PET and Spectra™ samples. This signifies that more dye was present in the dyed as-spun fiber compared to the other two fibers. FIGS. 3A-3C shows the effect of drawing on the measured fiber color for the dyed as-spun fiber. For the two draw stages, we observe very little color change with decreasing diameter. Furthermore, the color of the fibers after drawing are very similar to the PET fibers, and slightly darker red than the dyed Spectra™ fiber.

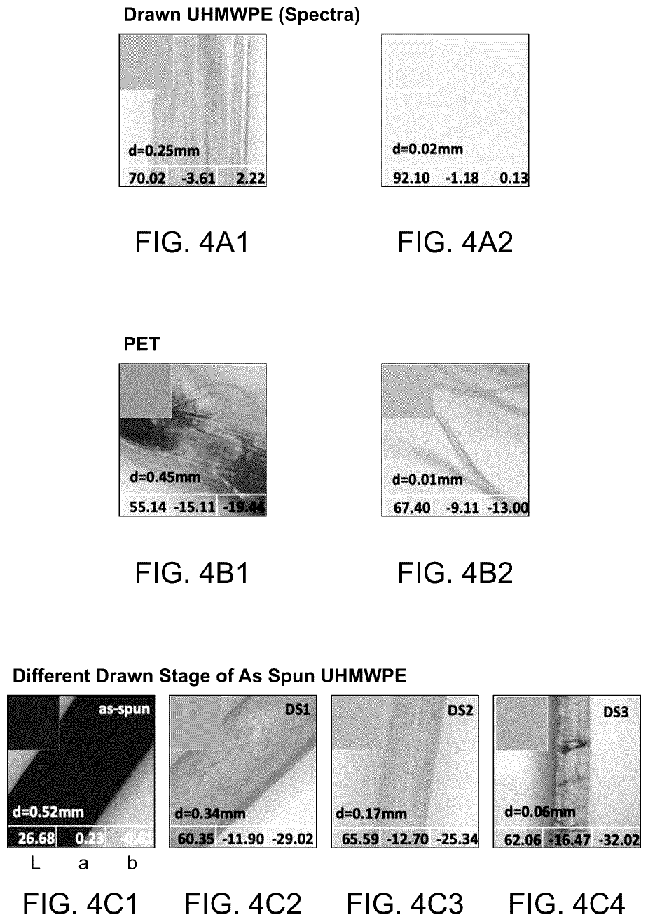

FIGS. 4A1-4C4 show the fibers colored using a green dye. The striking difference between red and green dyed Spectra™ fibers is that the green dyed Spectra™ fibers show almost no color, i.e. a very high L value. Overall, the Spectra™ fibers can be concluded to have minimal if no dye uptake for the green dye. On the other hand, the color of the dyed PET and as-spun fibers are much more vibrant. At the highest draw stage, the as-spun fiber shows a more vibrant blue than the PET fibers, suggesting a higher dye uptake. Note that the PET fibers show a slightly greenish tint in color, denoted by its smaller negative b value, while the UHMWPE fibers show a much bluer tint, i.e. more negative b value. The colors are close in both PET and UHMWPE with high dye uptake and vastly different vs. dyeing stretched UHMWPE, in which there is little dye uptake.

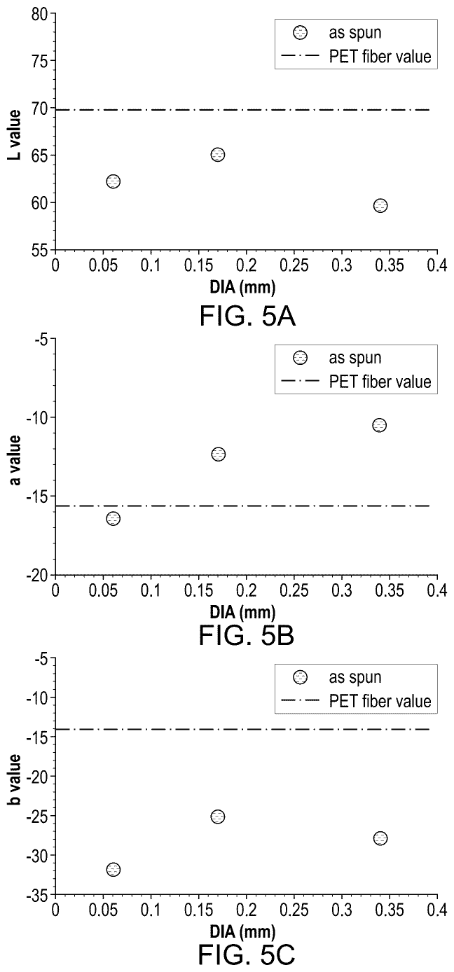

FIGS. 5A-5C show the effect of drawing on the Lab values for the green dyed as-spun fiber. We observe that the color is not strongly impacted by the decrease in diameter, but due in fact approach the values of the dyed PET fibers. This suggests a very similar dye uptake between PET and the dyed as-spun fiber, which are both markedly different from the dyed Spectra™ fiber.

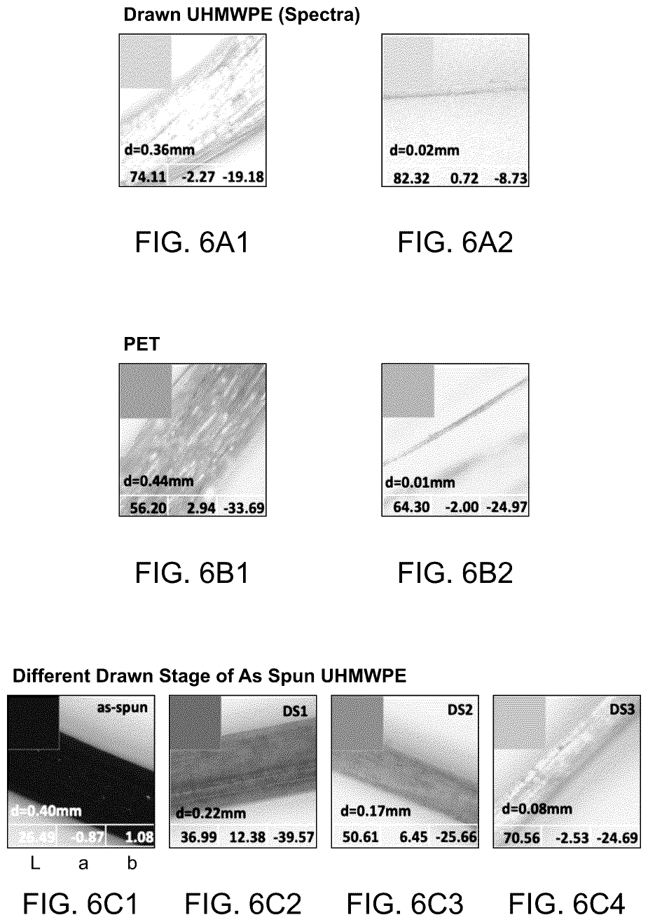

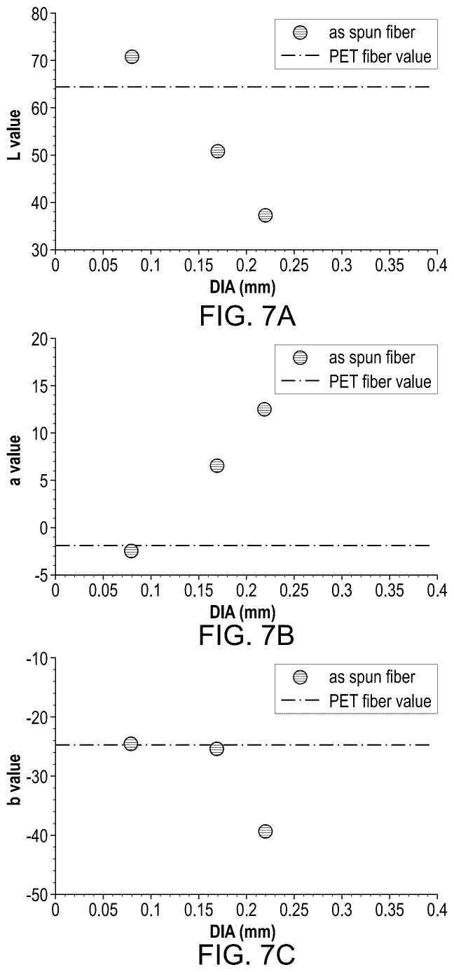

FIG. 6A1-6C4 show the color results for all fibers dyed with the violet dye. The color of violet Spectra™ fiber is more vibrant than the green UHMWPE Spectra™ fiber, but it is obviously less vivid than the red Spectra™ fiber. Similar to the red and green fibers, the violet PET fiber also shows a smaller L value than the commercial UHMWPE fibers, which indicates it also has a higher dye uptake than the commercial UHMWPE fibers. After several stages of drawing, the violet dyed as-spun fiber went from an immeasurable dark color to a purplish-blue. And as the drawing stages increased, the drawn as-spun fiber became lighter in color. At the highest draw stage (DS3), the as-spun fiber shows a similar color to the PET fibers, which indicates a similar color uptake. However, this fiber also shows a strong reflection, which means the actual color of the fiber might be more vibrant than measured with the microscope setup. FIGS. 7A-7C show the effect of drawing on the Lab values of the dyed as-spun fiber. We observe, similar to the green dye, that as the diameter of the fiber decreases, the more the Lab values approach that of the dyed PET fibers. This again suggests that the dye uptake of PET and as-spun UHMWPE fibers are similar, and much more concentrated than the dyed Spectra™ fiber.

One explanation for the significant differences observed between dyed Spectra™ and dyed as-spun UHMWPE fiber is their differences in crystallinity. Previously, it has been shown that there is a correlation between the dye uptake and the degree of crystallinity of UHMWPE fabrics dyed in scCO₂. Fibers with a higher degree of amorphous content showed higher levels of dye uptake. In this study, the Honeywell Spectra™ s-900 has a reported crystallinity greater than 92%, the PET fibers have a typical crystallinity between 30-50%, and the as-spun UHMWPE fibers have a reported crystallinity between 74-79%. Thus if the only important parameter was the degree of crystallinity, then we would expect the PET fibers to have the highest dye uptake, most intense dye color, and the Spectra™ fiber to have the lowest, i.e. least intense color. While it is clear that the PET fiber has more dye uptake than Spectra™ fibers, in some cases, the dye uptake in the as-spun UHMWPE fiber seems to be equal or slightly greater than that of PET, e.g. in the case of the red and green dye. This suggests that 21-26% amorphous content is sufficient to achieve dye saturation in the fiber. However, one must be cautious here since the drawn as-spun fiber and PET fibers are not being compared at the same diameter. It is possible that with more drawing, the dyed as-spun fiber would show less color than the PET fiber. This is supported by the trends in Lab with higher draw stages.

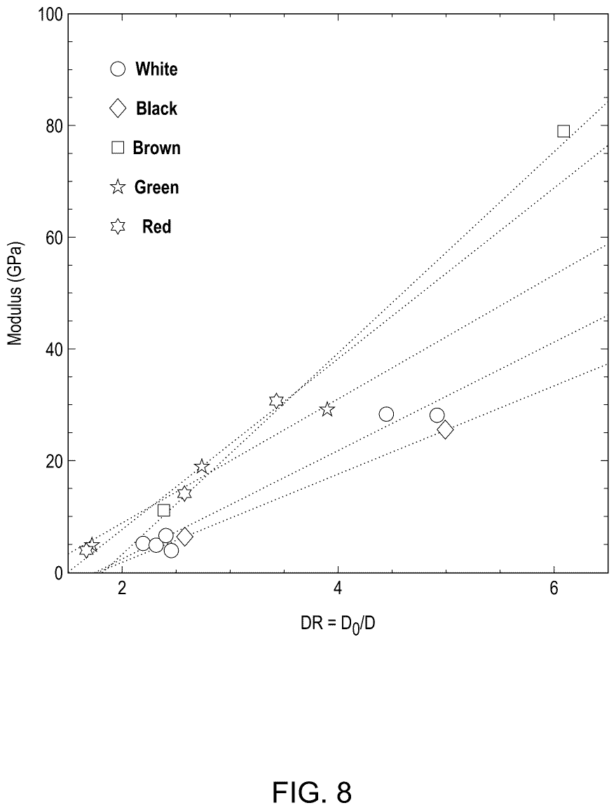

FIG. 8 shows the measured Elastic modulus (E) of undyed, black, brown, green and red fibers as a function of draw ratio (DR_{D}=D₀/D(DSi)), where D₀ is the as-spun diameter, and D(DSi) is the diameter measured at a given draw stage. The E of the fibers were obtained by the equation below:

E=τ/ε=ΔFL₀/AΔL Equation (1)

where τ is the stress on the fiber, ε=ΔL/L₀ is the axial strain, A is the cross sectional area of the fiber, and ΔL is the change in length of the fiber.

It was determined whether the presence of the dye has any effect on Mechanical properties undyed (white) fibers. Note that the undyed (white) fibers are considered a control as they are produced with the same spinning setup and treatment as the dyed fibers. The Modulus of the dyed fibers were higher or comparable with the undyed samples, which confirms that the supercritical dyeing process does not prevent the UHMWPE straight chain crystal evolution during drawing. Fibers with diameters around 200 μm, i.e. DR_{D}~3-5 had 10<E<40 GPa depending on color. The brown fiber was drawn to DR_{D}~6 or D_{f}~70 μm and had a modulus E=80 Gpa, which is close to the limit of commercially spun UHMWPE fibers. Spectra™ fibers have a diameter of ~20 μm and Modulus of at least about 110 Gpa. The tensile strength is between about 1 and about 9 Gpa.

In an exemplary embodiment, the tensile strength of the spun fiber is between about 1 and about 9 Gpa, and in an alternative embodiment, the tensile strength of the spun fiber is between about 7 and about 9 Gpa. The modulus of the spun fiber is at least 110 Gpa.

Interestingly, the inventors observed that at the same DR, Red and Brown fibers have a higher modulus than the green, white and black fibers for a given DRD. Overall the inventors observed that the dyeing process has no adverse effect on the ability for as-spun fibers to be drawn to high modulus fibers.

The colors of the post-drawn as-spun fibers are more vivid than the pre-drawn Spectra™ 900 fibers dyed under the same conditions. Indicating that dyeing the fiber prior to drawing is an effective method of achieving commercially relevant dye concentrations in UHMWPE fibers. Overall, the drawn UHMWPE as-spun fibers were able to achieve colors similar, if not more intense, to PET fibers that were dyed under the same conditions. These results show that effective dye uptake requires a certain degree of amorphous content in the fiber material. The data suggests that an amorphous content of approximate 30% is sufficient for effective dye uptake. Measurement of Elastic modulus for the dyed and undyed fibers show that neither the supercritical dyeing process nor the presence of dye molecules has any appreciable effect on the ability to draw as-spun fibers. The inventors have demonstrated that the inclusion of a scCO₂ dyeing step between spinning and drawing is a fascile way to achieve deep vibrant colors in UHMWPE fibers that can be post-drawn to achieve the desired mechanical properties. The colors achieved are expected to resemble the colors that can be readily achieved with PET fibers. This method will allow for UHMWPE to be more readily used in commercial applications that require a range of colors, especially applications that currently use PET fibers, but could benefit from UHMWPE fiber properties with the same color profile.

It will be further understood that various changes in the details, materials, and arrangements of the parts which have been described and illustrated in order to explain the nature of this invention may be made by those skilled in the art without departing from the scope of the invention as expressed in the following claims.

1. A method or coloring a ultra-high molecular weight polyethylene (UHMWPE) fiber comprising the steps of:
(a) gel spinning the UHMWPE fiber, the fiber having an amorphous content of about less than about 60%;
(b) drying the fiber;
(c) placing the fiber into a dyeing vessel;
(d) dissolving a dye in the dyeing vessel using super critical CO₂ and infusing the dye into the fiber;
(e) removing the fiber from the dyeing vessel; and
(f) hot drawing the fiber by a predetermined draw ratio to obtain a desired tensile strength and modulus for the fiber.

2. The method according to claim 1, further comprising, between step (b) and step (c), the step of winding the fiber onto a spool.

3. The method according to claim 2, further comprising, between step (d) and step (e), the step of unwinding the fiber from the spool.

4. The method according to claim 3, further comprising, after step (f), the step of re-spooling the fiber.

5. The method according to claim 1, further comprising, after step (f), the step of spooling the fiber.

6. The method according to claim 1, wherein the tensile strength is at between about 1 and about 9 GPa.

7. The method according to claim 6, wherein the tensile strength is between about 7 and about 9 GPa.

8. The method according to claim 1, wherein the modulus is at least 110 GPa.

9. The method according to claim 1, wherein step (d) comprises infusing an organic dye.

10. The method according to claim 1, wherein step (d) comprises using at least one of an azo, a di-azo, an anthraquinone, and a “disperse” type dye.

11. The method according to claim 1, wherein step (d) comprises infusing the dye into the spool-wound fiber by dispersing the dye at a temperature below the melting point of the as-spun fiber.

12. The method according to claim 1, further comprising the step of:
(g) twisting together multiple fibers formed by steps (a)-(f) to form a yarn.

13. The method according to claim 12, wherein steps (a)-(g) comprise a plurality of fibers formed together as a bundle.

14. The method of claim 1, wherein the dye is placed directly within the dyeing vessel.

15. The method according to claim 1, wherein the dye is placed in an external vessel.

16. The method according to claim 1, wherein the CO₂ is circulated within the dyeing vessel and through the spool with the wound fiber to transfer the dye from the CO₂ into the fiber.

17. The method according to claim 1, wherein CO₂ is circulated through the dyeing vessel and through the spool with the wound fiber to transfer the dye from the CO₂ into the fiber.

18. The method according to claim 1, further comprising, prior to step (d), the step of enclosing the dye in a semi-permeable pouch and placing the pouch in the dyeing vessel.

19. The method according to claim 18, further comprising, after placing the pouch in the dyeing vessel, filling the vessel with CO₂ to a desired pressure and a desired temperature to form scCO₂.

20. The method according to claim 1, further comprising, after filling the vessel with the scCO₂, circulating the scCO₂ within the vessel at a desired flow rate.

21. (canceled)

22. (canceled)
